(19) United States
(12) Patent Application Publication
(10) Pub. No.: US 2026/0210733 A1
(43) Pub. Date: Jul. 23, 2026

(54) Determining a Position of a Vessel in a Marine Environment

(71) Applicant: Furlong Sensing Ltd., Rugby (GB)

(72) Inventor: Russell MILES, Rugby, Warwickshire (GB)

(21) Appl. No.: 19/139,936

(22) PCT Filed: Dec. 18, 2023
(86) PCT No.: PCT/GB2023/053296

§ 371 Date: Jun. 17, 2025

(30) Foreign Application Priority Data
Dec. 18, 2022 (GB) 2219130.8

(51) Int. Cl. G01C 21/00; G01C 21/20

(52) U.S. Cl. CPC G01C 21/3848; G01C 21/005; G01C 21/203; G01C 21/3841

(57) ABSTRACT

A computer-implemented method of determining a position of a vessel in a marine environment involves obtaining image data representing the marine environment and obtaining position data from the vessel representing the position of the vessel in the marine environment. A map of the marine environment is generated based on the image data and the position data from the vessel. A map quality metric of the map is determined for a region of the marine environment and, in response to determining that the map quality metric for the region of the marine environment is greater than a map quality threshold, a position of the vessel is determined using the map without the need for position data from the vessel while the vessel is operating in the region.

### FIELD OF THE INVENTION

The invention relates to a computer-implemented method of determining a position of a vessel in a marine environment. The invention also relates to a device to determine a position of a vessel in a marine environment.

### BACKGROUND OF THE INVENTION

A Global Navigation Satellite System (GNSS) can provide an accurate position reference anywhere in the world to support navigation. GNSS is widely used to determine the position of vehicles, aircraft and marine vessels. However, GNSS suffers from a number of vulnerabilities which have the potential to limit its accuracy under certain circumstances.

Shadowing—GNSS receivers require a clear view of the sky in order to obtain a fix on the required number of satellites. As a result, GNSS receivers are usually placed high up on a vehicle or vessel to prevent the view of the sky from being blocked by the vehicle or vessel. When a vehicle moves through a built-up environment with tall buildings close to the road, those buildings may block the view of some or all of the satellites. Even if a multi-constellation receiver finds enough satellites to calculate a position, position accuracy can be significantly impaired.

Similar problems can occur in marine environments. For example, when a vessel passes under a bridge, some satellites may be obscured. In fact, if there is very little air clearance between the top of the vessel and the bottom of the bridge, it may not be possible to obtain a position at all when the vessel is substantially under the bridge. Likewise, when a vessel approaches an off-shore installation, such as an oil rig, the oil rig may tower above the vessel blocking a substantial part of the sky from view.

Multipath—GNSS is vulnerable to multipath error. For high accuracy work out in the open, multipath can be prevented using a survey grade antenna which has a ground plane which rejects any reflections coming from below. But when nearby clutter is higher than the antenna, the GNSS signal can bounce off that clutter and onto the antenna where it contaminates the line-of-sight signal.

The GNSS C/A code has a wavelength of 293 m. The P code wavelength is 29.3 m. This determines the distance resolution when observing GNSS signals. No amount of sophisticated signal processing can remove all the effect of multipath if the path length is less than 30 m longer than for the direct path.

Spoofing—an improperly terminated GNSS antenna can re-radiate the signal it receives, acting as a very bright reflector from the point of view of any other GNSS receiver in the vicinity. This has a very similar effect on nearby receivers as multipath. A malign actor may set up a GNSS re-transmitter deliberately to feed incorrect positions to neighbouring receivers.

Spoofing and multipath can sometimes be detected using RAIM (receiver autonomous integrity monitoring). By using two or more receivers, spoofing or multipath can be detected with improved confidence. Sometimes it may be possible to detect which satellite signals have been contaminated and exclude those from the position calculation. Often, the most that can be done is to indicate that the position calculation may be inaccurate-it is not possible to improve upon this inaccurate position.

Jamming—GNSS signals are low power. Despite being illegal in most countries, it is straightforward and cheap to generate a signal which swamps the GNSS signals for many hundreds of metres around the jammer. Jamming is very easy to detect and for some applications it is sufficient to suspend operations, and hunt down and disable the jammer. However, this may not always be a practical solution, for example, when it is not safe or practical to stop in the middle of an operation.

Therefore, there is a need to determine whether a GNSS position is accurate, and to have an alternative way to determine position in the event that the GNSS is not available or deemed inaccurate.

### SUMMARY OF THE INVENTION

According to a first aspect of the invention, there is provided a computer-implemented method of determining a position of an object in an environment. The method comprises obtaining image data representing the environment, obtaining position data from the object representing the position of the object in the environment, generating a map of the environment based on the image data and the position data from the object, and determining a position of the object using the map, without using position data from the object.

When accurate position data from the object is available (e.g., from GNSS), this position data can be used to identify the position of the object in the environment and, at the same time, the position data can be used in conjunction with images of the environment to build a three-dimensional map of the environment which may be continuously updated based on new images and position data as the object moves around the environment. This map can then be used to determine the position of the object, without the need for any position data. This allows the position of the object to be determined even when position data is not available (e.g., when shadowing or jamming prevents GNSS signals being received by a GNSS receiver) or when the position data is deemed inaccurate (e.g., as a result of multipath interference or spoofing affecting GNSS signals).

The object may be a vessel (such as a boat, ship, hovercraft or submarine) and the environment may be a marine environment. The method may comprise obtaining image data representing a marine environment, obtaining position data from a vessel representing the position of the vessel in the marine environment, generating a map of the marine environment based on the image data and the position data from the vessel, and determining a position of the vessel using the map, without using position data from the vessel.

The object may be a vehicle, for example, a car, truck, bus, coach, heavy equipment (including construction, mining, agricultural, and forestry vehicles), vessel (such as a boat, ship, hovercraft or submarine), train, helicopter, spacecraft, aircraft or drone.

The position of the object may be determined using the map when position data from the object is not available (e.g., when shadowing or jamming prevents GNSS signals being received by a GNSS receiver) or deemed inaccurate (e.g., as a result of multipath interference or spoofing affecting GNSS signals). An error between the position determined from the map and the position according to the position data from the object may be determined. This error may be used to deem the accuracy of the position data. For example, the position data may be deemed inaccurate when the error between the position determined from the map and the position according to the position data from the object is above an error threshold. The position of the object is determined using the map when position data from the object is deemed inaccurate based on the error.

The method may further comprise determining a map quality metric of the map for a region of the environment (such as a region of a marine environment). In response to determining that the map quality metric for the region of the environment is greater than a map quality threshold, a position of the object (such as a vessel) may be determined using the map without using position data from the object while the object is present or operating in the region. In other words, while an object is present or operating in a region of the environment that is sufficiently well-mapped (as indicated by a map quality metric), the position of the object can be determined solely from the map, without requiring position or orientation data from the object. For example, where the object is a vessel operating in a region of the marine environment that is sufficiently well-mapped as indicated by a map quality metric, the position of the vessel can be determined solely from the map without requiring live position data (such as live GNSS data) from the vessel.

While the map quality metric is below the map quality threshold, the map of the environment may be generated based on the image data and the position data from the object. While the map quality metric is above the map quality threshold, the position data from the object may be stored and the map may be updated based on the stored position data when the map quality metric falls below the map quality threshold.

The map quality metric may be determined as follows. The image data may comprise a time series of images, wherein each image represents the environment (such as a marine environment) around the object (such as a vessel) at a point in time. A plurality of frames may be generated, wherein each frame comprises one or more features extracted from an image of the time series of images and at least some of the plurality of frames comprise a position fix based on position data from the object (for example, where the object is a vessel, the position fix may be based on position data, such as GNSS data, from the vessel). The map may be generated based on key frames selected from the plurality of frames. One or more map points may be generated, wherein each map point identifies the position of a feature in the environment based on the position data from the object. Determining the map quality metric may comprises obtaining current image data representing the region of the environment, generating a current frame comprising one or more features extracted from the current image data, and determining the map quality metric based on the map points associated with features in the current frame and features in the key frames having a position fix.

The map quality metric may be determined by counting the number of map points associated with features in the current frame and features in the key frames having a position fix. The map quality threshold may be based on the count.

The map quality metric may be determined based on topological distance between the current frame and key frames having a position fix. The map quality metric may be above the map quality threshold when the topological distance is less than a topological distance threshold.

The image data may be obtained from one or more image capture devices located on the object. Each image capture device may be a two-dimensional image capture device (such as a camera), or a three-dimensional image capture device (such as an RGB-D camera or lidar).

The position data may comprise global navigation satellite system (GNSS) data.

Orientation data may be obtained (for example, from an inertial sensor on the object) representing the orientation of the object in the environment. Generating the map of the environment may be further based on the orientation data, and the orientation of the object may be determined using the map without using orientation data from the object.

Generating the map (preferably a three-dimensional map) may comprise extracting one or more features from the image data and generating one or more map points, where each map point identifies the position of a feature in the environment based on the position data from the object.

The one or more features may comprise one or more of corner features and line features in the image data. Corner feature detection is preferable in a marine environment because strong informative lines are less common in the marine environment. Corner detection algorithms may include a Harris detector, Shi-Tomasi, SIFT, SURF, FAST, BRIEF, and ORB.

Determining the position of the vessel using the map, without using position data from the vessel, may comprise obtaining current image data representing the environment, extracting one or more features from the current image data, identifying map points associated with each of the one or more extracted features from the current image data, and calculating the position of the object based on the position of the map points associated with each of the one or more extracted features from the current image data.

The image data may comprise a time series of images, where each image represents the environment around the object at a point in time. A plurality of frames are generated, wherein each frame comprises one or more features extracted from an image of the time series of images.

Generating the map may comprise defining one or more tracks for a first frame of the plurality of frames, wherein each of the one or more tracks associates a feature in the first frame with a map point. At least some of the one or more tracks may be extended by matching the track with a corresponding feature in one or more subsequent frames of the plurality of frames. The position of the object in a current frame may be determined based on the position of map points matched to features in the current frame by the tracks.

Matching a track with a corresponding feature may be based on one or more of: the distance between the track and the corresponding feature, and the characteristics of the features.

Matching the track with a corresponding feature in one or more subsequent frames may comprise predicting the position of the corresponding feature in the one or more subsequent frames, for example, using a Kalman filter. The position of the corresponding feature in the one or more subsequent frames may be predicted based on the relative orientation of the vessel between frames.

In response to a track failing to match with a corresponding feature in one or more subsequent frames, the track may be extrapolated between frames or deleted.

The method may comprise identifying one or more map points that are not associated with a track. In response to determining that an identified map point that is not associated with a track is expected to be visible in the current frame, matching an unassociated feature in the current frame with the identified map point, and defining a track for each of the map points matched with an unassociated feature.

A map point may be removed from the map in response to the removed map point matching no features over a number of frames exceeding a removal threshold.

The map may be generated from key frames selected from the plurality of frames.

A new key frame may be added to the map in response to one or more of:
the number of tracks in a current key frame falling below a track threshold;
a distance travelled by the object from the current key frame exceeding a distance threshold;
the number of map points associated with the current key frame that are not associated with the current frame exceeding an association threshold;
a minimum number of maps points being associated with the current frame; and
the new key frame, or a neighbouring key frame, having associated position data, and optionally orientation data, from the object that is not deemed inaccurate.

Neighbouring key frames may have at least one map point in common. Neighbouring key frames may be determined using a covisibility graph.

A key frame may be removed from the map in response to determining that the key frame is redundant based on the number of map points that are duplicated in other key frames. A key frame may be deemed redundant when the map points duplicated in other key frames are found at the same or finer scale in the other key frames.

The method may further comprise performing a bundle adjustment which adjusts a pose of an image capture device associated with one or more key frames and/or one or more maps points to minimise a reprojection error and/or an error between the calculated position of the object and the position data from the object. The bundle adjustment may remove tracks from the map that cause a reprojection error to exceed a reprojection error threshold.

The object may be declared lost in response to a number of tracks falling below a track threshold. In response to declaring the object lost, the method may comprise relocalising the object in the map. Relocalising the object in the map may be based on the current position data from the object and current image data representing the environment. Relocalising the object in the map may involve using particle filter relocalisation. Alternatively, in response to declaring the object lost, the method may comprise generating a new map.

The map may be generated as the object (such as a vessel or vehicle) moves around the environment. Optionally, the map is generated on a plurality of visits by the object (or by other objects, such as other vessels or vehicles) to a region of the environment.

The method may further comprise merging the map with a shared map stored on a server and updating the map based on the shared map. The shared map may comprise map data generated by a plurality of objects (such as a plurality of vessels or vehicles).

According to a second aspect of the invention, there is provided a device to determine a position of an object (such as a vessel or vehicle) in an environment, the device comprising a processor configured to carry out a method according to the first aspects.

According to a third aspect of the invention, there is provided a computer-readable medium having instructions which, when executed be a processor, cause the processor to carry out a method of determining a position of an object (such as a vessel or vehicle) in a marine environment according to the first aspect.

According to a fourth aspect of the invention, there is provided a system to determine a position of an object (such as a vessel or vehicle) in an environment. The system comprises:
an image capture device (such as a camera, RGB-D camera or lidar) configured to provide image data representing the environment; and
a device comprising a processor configured to:
   receive the image data representing the environment from the image capture device;
   receive position data representing the position of the object in the environment from a position sensor (such as a GNSS receiver) on the object;
   generate a map of the environment based on the image data and the position data; and
   determine a position of the object using the map, without using position data from the position sensor on the object.

The processor may be further configured to determine a map quality metric of the map for a region of the marine environment and, in response to determining that the map quality metric for the region of the marine environment is greater than a map quality threshold, determine a position of the vessel using the map without using position data from the position sensor on the vessel while the vessel is operating in the region.

### BRIEF DESCRIPTION OF THE DRAWINGS

The invention shall now be described, by way of example only, with reference to the accompanying drawings in which:

FIG. 1 illustrates a vessel in a marine environment including a system for determining the position of the vessel without requiring GNSS position data;

FIG. 2 illustrates a method for intrinsically calibrating a camera;

FIG. 3 illustrates the position determining system of FIG. 1 in more detail;

FIG. 4 illustrates a method for building a three-dimensional map;

FIG. 5 illustrates a method for determining the position of the vessel using the three-dimensional map alone, without using any GNSS position data; and

FIGS. 6 to 8 illustrate the process of building and maintaining a map.

### DETAILED DESCRIPTION

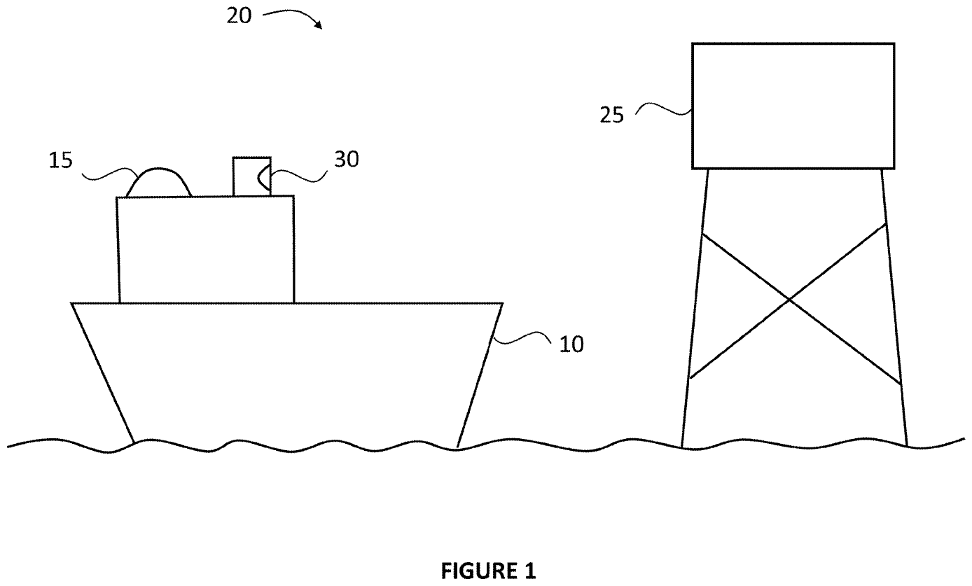

FIG. 1 illustrates a vessel 10 in a marine environment 20 which includes a system for determining the position of the vessel 10 in the event that GNSS data is not available or is deemed inaccurate.

The system can be useful on any vessel which needs to manoeuvre, or maintain position, to high precision, operating across a range of different marine environments. Some examples include:
a platform supply vessel which needs to maintain its position with respect to an oil rig during a load transfer operation;
a wind turbine maintenance vessel which needs to maintain its position with respect to a wind turbine tower during the deployment of a “walk to work” platform for crew transfer; and
any vessel attempting to dock when it comes into port. This is particularly important for a vessel which need to regularly dock quickly and safely (such as passenger ships).

The vessel 10 has a GNSS receiver 15 which can output position data representing the position of the vessel 10 in the marine environment 20. When accurate GNSS position data is available from the GNSS receiver 15, the GNSS position data can be used to identify the position of the vessel 10 in the marine environment 20 in the usual way. At the same time, the GNSS position data can be used in conjunction with images of the marine environment 20 captured by a camera 30 to build a three-dimensional map of the marine environment 20. The map is continuously updated based on new images and GNSS position data as the vessel 10 moves around the marine environment 20. This map can then be used to determine the position of the vessel 10, without the need for any GNSS position data. This allows the position of the vessel 10 to be determined even when GNSS position data is not available or when the GNSS position data is deemed inaccurate.

The camera 30 is usually placed in a location where it has a largely unobstructed view of the marine environment 20. In this example, the camera 30 is mounted on the outside of the vessel 10, in a waterproof housing. Usually, a windscreen wiper keeps the lens clear of rain and spray. Alternatively, the camera 30 could be installed inside the bridge, looking through an area kept clear by a windscreen wiper. As the camera 30 has a wide field of view, a single camera is often sufficient. Additional cameras can be provided if wider coverage is required (for example, on a large vessel), or where the view from any camera is unavoidably obscured (for example, by part of the vessel).

The camera 30 needs to be intrinsically and extrinsically calibrated.

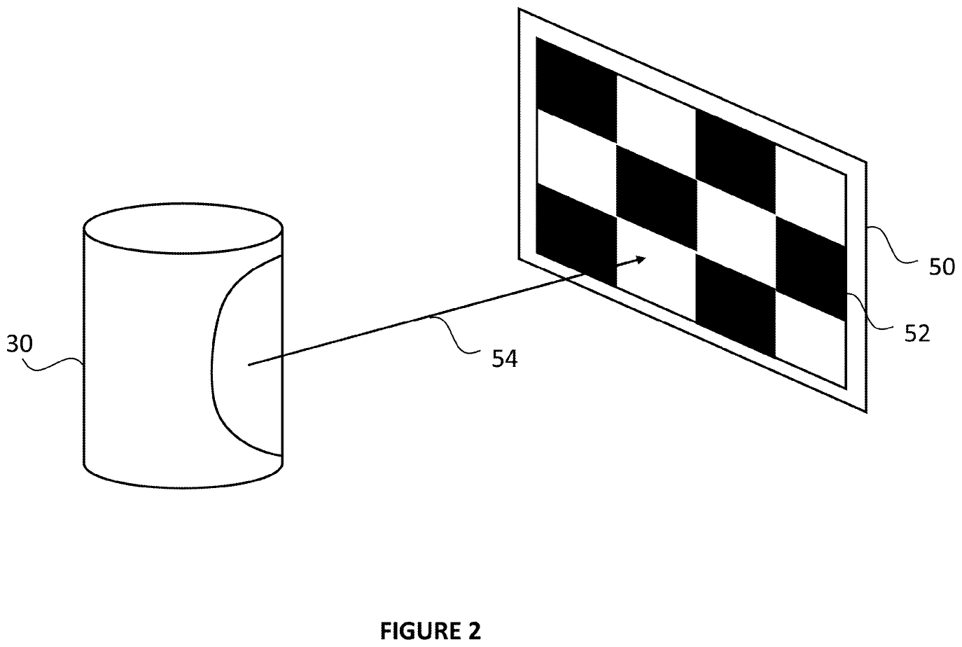

FIG. 2 shows an example technique for determining intrinsic calibration parameters for the camera 30. The camera 30 is placed in front of a flat calibration pattern 52, for example, displayed on monitor 50. Images of the calibration pattern 52 are captured by the camera 30.

At least three images of the calibration pattern 52 are captured from different angles, ideally with the calibration pattern 52 filling each of the images. For example:
(1) The first image has the plane of the calibration pattern 52 approximately perpendicular to the axis 54 of the camera 30.
(2) The second image has the plane of the calibration pattern 52 at a substantial angle (such as 45 degrees) to the camera axis 54
(3) The third image has the plane of the calibration pattern 52 at the opposite substantial angle to the camera axis 54 of the second image (such as −45 degrees).

The intrinsic calibration parameters (such as radial distortion, optical centre and focal length of the camera 30) can be determined by processing the images with a camera calibration algorithm, such as those found in the OpenCV library.

Once the camera 30 has been installed on the vessel 10, and while the vessel 10 is still in a port, the camera 30 is extrinsically calibrated to establish the precise pose (position and orientation) of the camera 30 with respect to a reference point on the vessel 10. For example, a surveying detail pole could be moved around the field of view of the camera 30. By determining the position of the detail pole accurately using differential GNSS (DGNSS), the position of the detail pole in images taken of the detail pole placed in different positions within the field of view of the camera 30 can be used to determine the pose of the camera 30 with respect to the GNSS receiver 15 on the vessel 10. Once the vessel 10 has left port and is out at sea, an estimate of the inclination of the camera 30 can be improved by horizon detection.

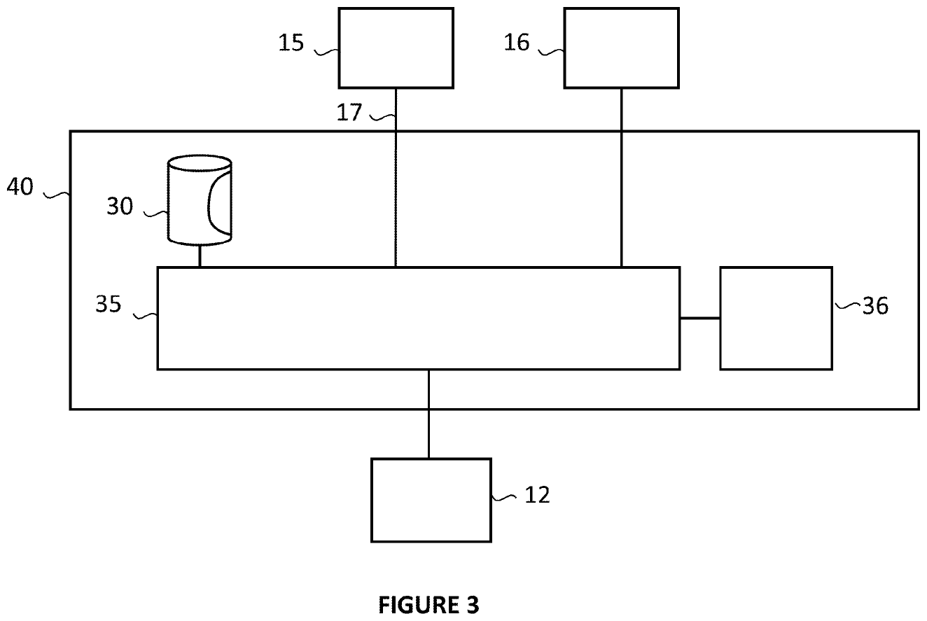

FIG. 3 illustrates the system 40 for determining the position of the vessel 10 in the event that GNSS data is not available or is deemed inaccurate. The camera 30 sends images of the marine environment 20 to a computer 35 over ethernet or another suitable communication link. The computer 35 is, for example, an industrial PC certified for marine use (IEC 60945) running Windows IoT.

The computer 35 receives GNSS data formatted according to a standard GNSS data protocol (such as NMEA, RTCM3 or UBX) from the GNSS receiver 15 over a suitable communication link 17, such as ethernet or serial (e.g., RS-422 or RS-485). The GNSS data includes GNSS position data indicating the position of the vessel 10 in the marine environment 20.

The computer 35 obtains orientation data indicating the orientation of the vessel 10. The orientation data can be provided by inertial sensor 16 or GNSS data from a multi-antenna GNSS receiver capable of indicating the orientation of the vessel 10. The inertial sensor orientation data may be used either alone or in combination with the GNSS orientation data. The orientation data may also be generated endogenously from the GNSS position data and camera images of the marine environment 20, without the need for an inertial sensor or multi-antenna GNSS receiver. Obtaining orientation data from an inertial sensor 16 is preferable since they are not susceptible to external interference (since inertial sensors do not rely on external signals, such as GNSS satellite signals) and the use of two or more inertial sensors can provide orientation data integrity in the unlikely event of inertial sensor malfunction (since it is unlikely that all of the inertial sensors will malfunction in the same way at the same time).

The computer 35 can compare the GNSS position data from the GNSS receiver 15 with the position of the vessel 10 calculated from the map, to assess whether or not the GNSS position data is likely to be accurate. Optionally, the computer 35 can compare the orientation data with the orientation of the vessel 10 calculated from the map, to assess whether or not the orientation data is likely to be accurate.

The computer 35 may be connected to a dedicated display 36 using ethernet or another suitable communication link. The display 36 may show the current position (from whichever is the more accurate of the map or GNSS position data). The display 36 may also display an indication of the accuracy of any current GNSS position data. The display 36 may optionally show the current orientation (from whichever is the more accurate of the map or the orientation data). The display 36 may also display an indication of the accuracy of any current orientation data.

Additionally, or alternatively, the computer 35 may be connected to a vessel bridge system 12 over ethernet or another suitable communication link. The computer 35 provides to the vessel bridge system 12 the current position (and optionally orientation) and, if desired, an indication of their accuracy, which the vessel bridge system 12 may use in controlling the position of the vessel 10.

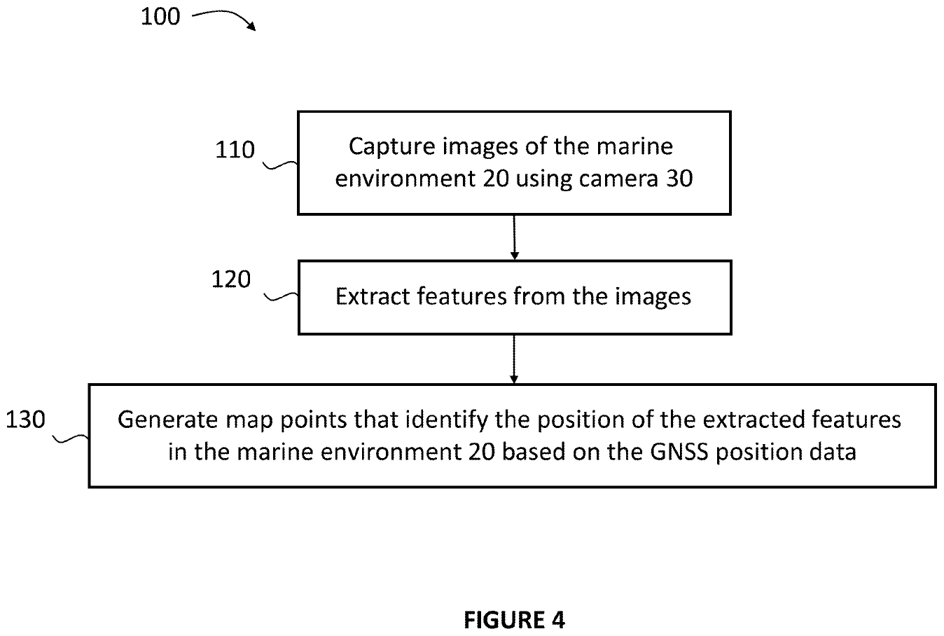

FIG. 4 illustrates a method 100 for building the three-dimensional map. At step 110, the camera 30 captures visible light images of the marine environment 20 including any visible objects (such as off-shore installation 25). At step 120, distinctive features in the images associated with the objects are extracted using a suitable feature extraction algorithm. Typically, corner features associated with objects in the images are extracted using a corner detection algorithm. Lines features can also be extracted, but corner features tend to be more prevalent in the marine environment. At step 130, the GNSS position data from the GNSS receiver 15 is used to label the position in the marine environment 20 of the features extracted from the images which are stored as map points in the map.

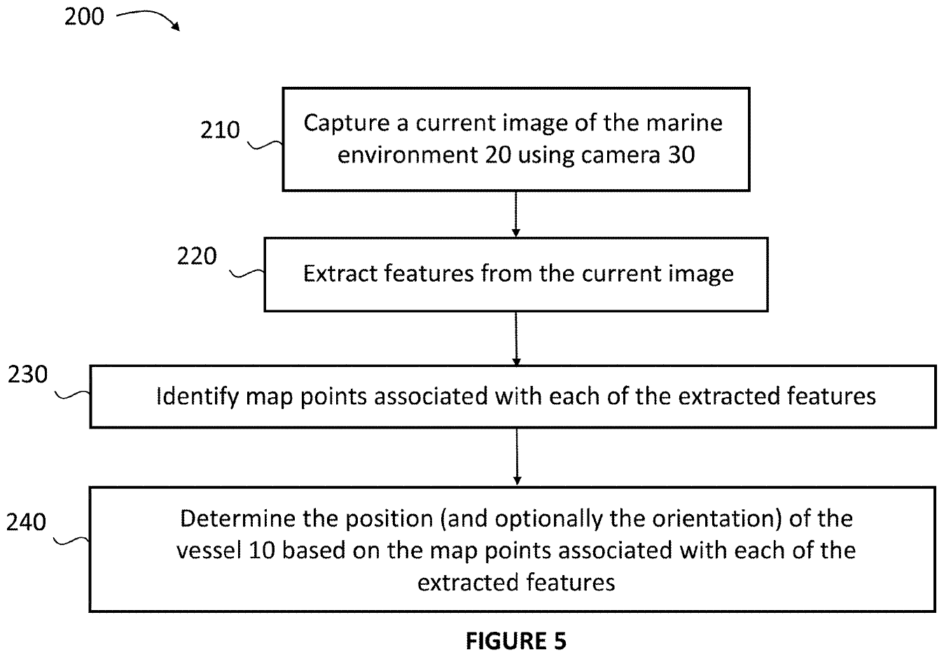

FIG. 5 illustrates a method 200 for determining the position (and optionally the orientation) of the vessel 10 using the three-dimensional map alone, without using any GNSS data from the vessel 10. The method 200 can be used to determine the position (and optionally the orientation) of the vessel 10 even when GNSS data is not available or when the GNSS data is deemed inaccurate. At step 210, a current image representing the marine environment 20 is captured by the camera 30. At step 220, distinctive features are extracted from the current image data (in the same way described in step 120 above). At step 230, map points associated with each of the one or more extracted features from the current image are identified in the map. At step 240, the position of the vessel 10 is calculated based on the map points associated with each of the one or more extracted features from the current image data. Optionally, the orientation of the vessel 10 can be calculated based on the map points associated with each of the one or more extracted features from the current image data.

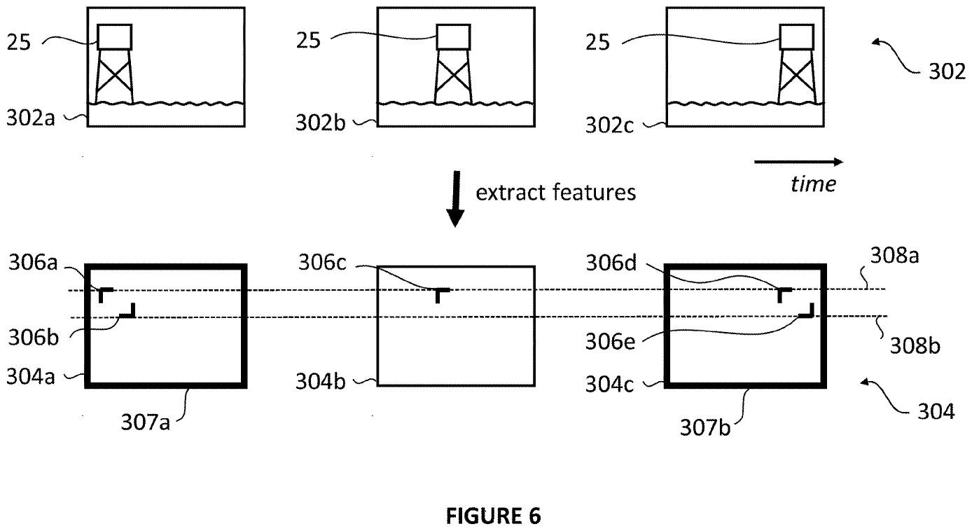

The method of building and maintaining the map shall now be described in more detail with reference to FIGS. 6 to 8.

### Map Building

As shown in FIG. 6, the camera 30 captures a time series of images 302 with each image 302a-302c representing the marine environment 20 around the vessel 10 at a different point in time. Each image 302a-302c includes any objects (such as off-shore installation 25) that are visible in the field of view of the camera 30 at the time of capture. Frames 304 are generated by extracting one or more features 306 from the images 302a-302c, for example, corner features 306a-306e associated with the off-shore installation 25.

Assuming a frame 304 meets the key frame criteria of having sufficient extracted features 306 in the frame 304, the set of features 306 is stored as a key frame 307, along with the recorded pose (recorded position and recorded orientation) of the camera 30 recorded at the time the associated image 302 was captured The recorded position of the camera 30 is derived from the GNSS position data and the recorded orientation of the camera 30 is derived from the orientation data (preferably from the inertial sensor 16). If GNSS position data is not available at exactly the same time the image 302 was captured, the position data may be interpolated from the available GNSS position data around the time the image 302 was captured. The key frame 307 may have additional information associated with it, such as the time the frame was captured.

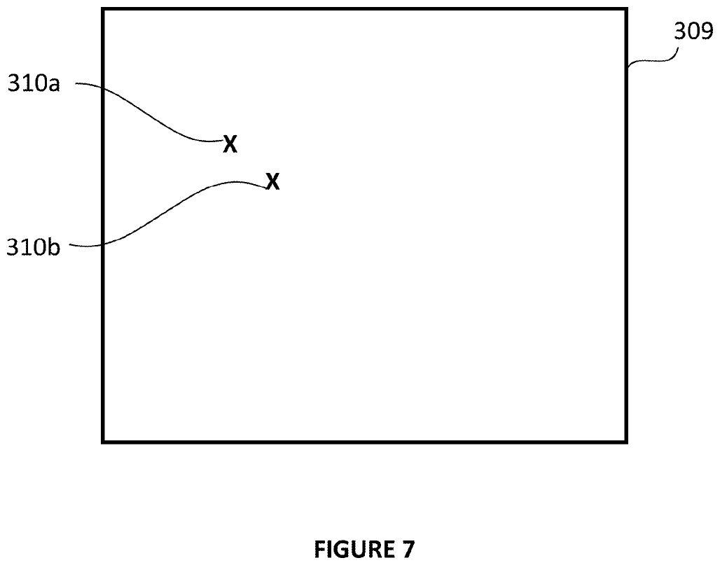

For each feature 306 in a key frame 307, a track 308 is defined which associates that feature with a corresponding map point 310 in the map 309 shown in FIG. 7 (each key frame feature may be associated with at most one map point 310, and each map point 310 may be associated with at most one feature in each key frame). The map points 310 define the likely position where the features 306 will be found in the marine environment 20 derived from the GNSS position data recorded at or around the time the image 302 was captured. The map points 310 may contain other information which is used to predict the appearance of the feature 306, such as, descriptor, scale and orientation angle.

### Initialising the Map

The map building process starts with initialising the map 310. A first image 302a is grabbed from the camera 30 and a frame 304a is generated by extracting one or more features 306a, 306b from this first image 302a. If the frame 304a meets the key frame criteria, the set of features 306a, 306b extracted from the first image 302a is stored as a first key frame 307a in the map. The first key frame 307a is stored along with the recorded pose (recorded position and recorded orientation) of the camera 30 that was recorded at or around the time the first image 302a was captured. The recorded position of the camera 30 is derived from the GNSS position data and the recorded orientation of the camera 30 is derived from the orientation data (preferably from the inertial sensor 16). For each feature 306 in this first key frame 307a, a track 308 is defined which associates the feature 306 with a corresponding map point 310 in the map 309. Track 308a associates feature 306a with map point 310a and track 308b associates features 306b with map point 310b.

As subsequent frames 304 are generated, features 306 are extracted from each frame 304 and an attempt is made to associate those features with existing map points 310 using the tracks 308. For each feature 306, a distance is measured to each track 308 in terms of image position and the other characteristics of the features 306 such as descriptor and scale. A feature 306 is matched to at most one track 308—this is the nearest track 308 where the distance is below a matching threshold.

If a match is made between a feature 306 and a track 308, the feature 308 is used to update the matching track 308. In its simplest form, the track 308 merely adopts the new position and descriptor from the matched feature 308 in each frame 304. A more sophisticated approach processes information from a sequence of matches to extrapolate the track 308 and predict where the feature 306 will appear in a future frame 304. A change in orientation between frames 304 can be determined from the orientation data, which can also help to extrapolate tracks 308 to better predict the position of a feature 306 in a future frame 304. A wide variety of techniques are available to make predictions of the position and appearance of a feature 306 in a future frame 304, for example, the Kalman filter.

If no match is found between a track 308 and any of the features 306 in a frame 304, the track 308 can be extrapolated across future frames and an attempt made to match the extrapolated track with features in future frames. The track 308 may be deleted if no match continues to be found. For example, the track 308 may be deleted if no match is found over a sequence of frames 304 (e.g., where the number of frames in the sequence of frames 304 exceeds a removal threshold). Additionally or alternatively, the track 308 may be deleted if the track 308 has been associated with its corresponding feature 306 less than a minimum number of times over a sequence of frames 304. If the number and distribution of tracks 308 falls below a track threshold, the first key frame 307a is discarded and a new first key frame is created.

In the example in FIG. 6, a second image 302b is grabbed from the camera 30 and a frame 304b is generated by extracting feature 306c from this second image 302b. A match is made between the feature 306c and the track 308a so the feature 306c is used to update the track 308a. However, no match is found between track 308b and any feature in the second image 304b, so the track 308b is extrapolated forwards until the next (third) image 302c is grabbed from the camera 30. When the third image 302c is grabbed from the camera 30, frame 304c is generated by extracting features 306d and 306e from this third image 302c. A match is made between the feature 306d and the track 308a so the feature 306d is used to update the track 308a. A match is made between the feature 306e and the track 308b so the feature 306e is used to update the track 308b.

Once the distance travelled by the vessel 10 from the first key frame 307a to the current frame is above a distance threshold, the current frame 304c is stored as a second key frame 307b and the map 309 can be initialised. For each track 308:
a position in the marine environment 20 is calculated which best matches the position of the feature 306 in the image 302a associated with the first key frame 307a, the pose (position and orientation) of the camera 30 in the first key frame 307a, the position of the corresponding feature 306 in the image 302c in the second key frame 307b and the pose (position and orientation) of the camera 30 in the second key frame 307b. This gives four constraints over three unknowns.
A check is made that the difference between the position of the feature (e.g., 306a) in the image 302a associated with the first key frame 307a and the position of the corresponding feature (e.g., 306d) in the second key frame 307b are compatible with the calculated change in pose (position and orientation) of the camera 30 between the first 307a and second 307b key frames, that is that they satisfy the epipolar constraint to sufficient accuracy. If the calculated position in the marine environment 20 and the camera positions for the first 307a and second 307b key frames are nearly colinear, it is not possible to calculate the position in the marine environment 20 with sufficient accuracy.
Provided that the epipolar constraint and the non-collinearity requirement are satisfied, a map point 310 is created for the track 308. This map point 310 associates a feature 306 in the first key frame 307a with the corresponding feature 306 in the second key frame 307b (e.g., map point 310a associates feature 306a in the first key frame 307a with feature 306d in the second key frame 307b).

### Updating Tracks

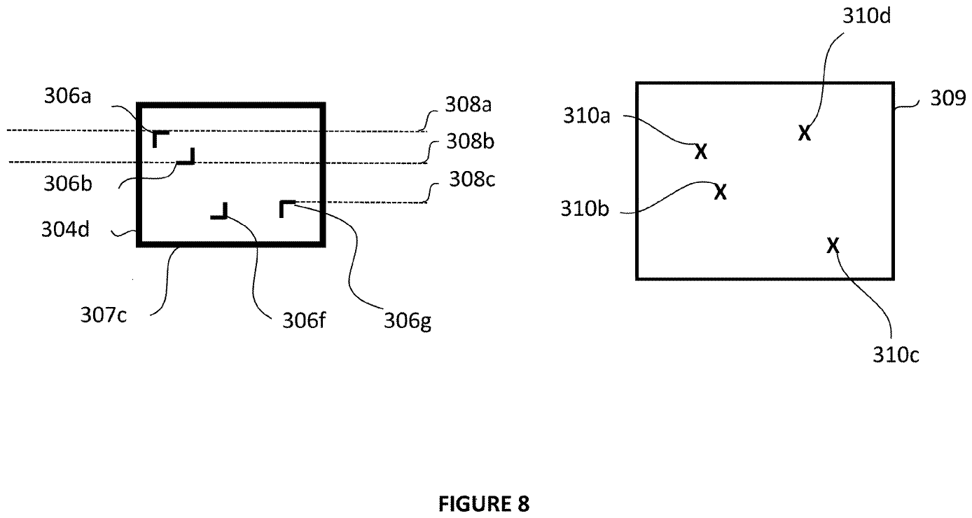

Once the map 309 has been initialised in FIG. 6, the tracks 308 continue to be updated as new frames 304 are created. A new frame 304d is created in FIG. 8 by extracting a set of features 306 from an image 302 captured by the camera 30. An attempt is made to match each track 308 to a feature 306 in the new frame 304d in order to update that track 308 and associate a feature 306 in the new frame 304d with a map point 310 in the map 309. If a track 308 is not matched with a feature 306 over a number of subsequent frames 304 (as described above), the track 308 is deleted.

Once all the existing tracks 308a, 308b have been updated for the new frame 304d, a search may be conducted through map points 310 which are not associated with a track 308 in the new frame 304. For each unassociated map point 310c, 310d, it is determined whether it should generate a feature given the pose of camera 30 in the new frame 304d. For example, the map point 310c should be visible, so a feature generated by the map point 310c is predicted. An image position is calculated for the predicted feature as well as the descriptor and other feature parameters such as scale and orientation. A search is conducted through unassociated features 306f, 306g in the current frame 304d to find matches with the features predicted for the unassociated map point 310c. In this example, a match is found between unassociated feature 306g and unassociated map point 310c, so a new track 308c is started for map point 310c.

Features 306 detected in the current frame 304 and the positions of the map points 310 associated with those features 306 can be used to calculate the current pose (position and orientation) of the camera 30 in the marine environment 20. This is an over constrained problem. We have only six degrees of freedom, but we have 2n constraints, where n is the number of feature-to-map point matches in the current frame 304. A non-linear least-squares fit can be performed to find a pose of the camera 30 which minimises the reprojection error, for example, using the Levenberg-Marquardt algorithm. Given the pose of the camera 30 relative to the vessel 10 is known from the extrinsic calibration, the position (and optionally the orientation) of the vessel 10 can be determined. During this calculation, any feature-to-map point associations which give a large residual error are noted and associated tracks deleted as not being true matches.

### Adding New Key Frames to the Map

A new key frame 307c may be added to the map 309 in response to one or more of the following criteria being met:
Any Bundle Adjustment Calculations Trigged by the Latest Addition of a Map Point 310 are complete;
the number of tracks 308 in the current key frame 307b falling below a track threshold;
a distance travelled by the vessel 10 since the current key frame 307b exceeds a distance threshold;
the number of map points 310 associated with the current key frame 307b that are not associated with the current frame 304d exceeds an association threshold (for example, less than 10% of the map points 310 associated with the current key frame 307b are associated with the current frame 304d);
a minimum number of maps points 310 (for example, 50 map points) are associated with the current frame 304d; and
the new key frame 307c, or a neighbouring key frame, have associated GNSS position data (and optionally orientation data).

The new key frame 307c is based on the current frame 304d. An association is added for each track 308a-308c associated with the current frame 304d. An attempt is made to associate any unassociated features in the new key frame 307c, such as unassociated feature 306f, with unassociated features in neighbouring key frames. Neighbouring key frames are those key frames 307 having at least one map point 310 in common. Neighbouring key frames may be determined using a covisibility graph which maps which key frames 307 are associated with at least one of the same map points 310.

For each neighbouring key frame, the pose of camera 30 is calculated relative to the new key frame 307c. Then, for each unassociated feature in the new key frame 307c, such as unassociated feature 306f, an epipolar line in the image of the neighbouring key frame is calculated. The unassociated features in the neighbouring key frame which are close to this epipolar line and close to the unassociated feature 306f in the new key frame 307c in terms of appearance (descriptor, scale, etc) are found. If the closest feature is sufficiently close (below the matching threshold), a new map point is created. Given the pose of the camera 30 in the current 307b and new 307 c key frames, and the positions of the matched features in the current 307b and new 307c key frames, the position of the map point is calculated which minimises the reprojection error, using the same technique as for map initialisation. A search is made through unassociated features in other neighbouring key frames 307 to see if further associations with unassociated map points can be made.

### Map Management

Whenever a new map point 310 in added to the map 309, there is a performance monitoring period during which the performance of the new map point 310 is monitored until a number of new key frames 307 have been added to the map 309 (for example, until three key frames have been added). During this performance monitoring period, it is counted:
the number of times the map point 310 is matched with a frame feature 306 (the number of “good matches”), and
the number of times the map point 310 is not matched with a frame feature 306 even though the map point 310 is in the field of view of the camera 30 according to the current estimate of camera pose (the number of “missing matches”).

If, during the performance monitoring period for a new map point 310, the number of missing matches outnumbers the number of good matches by a ratio (for example, 3:1), the new map point 310 is removed from the map 309.

Whenever a new key frame is added to the map 309, a search is conducted through the existing key frames to find and delete any redundant key frames 307. A key frame 307 is classified as redundant if a large number (for example, more than 90%) of its map points 310 are found in other keyframes 307 (for example, at least 3 other key frames) in the same or finer scale, as described “ORB-SLAM: a Versatile and Accurate Monocular SLAM System” Raul Mur-Artal, J. M. M. Montiel and Juan D. Tardos, IEEE Transactions on Robotics, 2015, which is incorporated herein by reference.

### Bundle Adjustment

Once a new key frame, such as key frame 307c, is added to the map 309, along with any new map points 310 and associations between features 306 and map points 310, a local bundle adjustment can be performed to calculate a pose of the camera 30 starting with the recorded pose and then adjusting the pose of the camera 30 associated with the new key frame 307c and its neighbouring key frames, and the position of the map points 310 which are visible from any of those key frames, to minimise a cost function using a non-linear least squares calculation such as the Levenberg-Marquardt algorithm.

The cost function is comprised of two parts: (1) reprojection error and (2) the error between the recorded GNSS position data and inertial orientation data, and the calculated pose of the camera 30.

Any associations between features 306 and map points 310 which result in a large reprojection error are assumed to be a mismatch and excluded from the bundle adjustment. The error between the recorded GNSS position data and inertial orientation data, and the calculated pose of the camera 30, is formed of two parts:
For the first part, the error between the recorded GNSS position data and inertial orientation data, and the calculated pose of the camera 30, is calculated for each key frame 307.
For the second part, the key frames 307 are ordered according to the timestamp of their recorded GNSS position data. Then, for each pair of consecutive key frames, the change in calculated pose of the camera 30 relative to the change in pose according to the recorded GNSS position data and inertial orientation data is calculated. A weighting is applied to each pair which is inversely proportional to the time elapsed between each key frame 307. This second part takes into account the fact that errors in recorded GNSS position data and inertial orientation data are strongly auto-correlated over time, that is, subject to a slowly drifting offset error.

GNSS position data and inertial orientation data is also subject to outlier tests. Any GNSS position fix that leads to a significant residual position error between the position of vessel 10 reported by the GNSS receiver 15 and the position of the vessel 10 calculated by the map 309 is excluded from the bundle adjustment calculation, and the GNSS receiver 15 is declared to have been operating badly at the time the GNSS position fix was obtained. Any orientation data that leads to a significant residual orientation error between the orientation of the vessel 10 according to the orientation data and the orientation of the vessel 10 calculated by the map 309 is excluded from the bundle adjustment calculation, the device providing orientation data (such as the inertial sensor 16) is declared to have been operating badly at the time it provided the orientation data.

Any GNSS position data, and any orientation data, which are excluded from the bundle adjustment are nevertheless retained in the map 309 and available to future bundle adjustment calculations where the data may be returned to the inlier set, as different associations may be made in the future when more data is available.

Local bundle adjustment is computationally demanding. It is usually performed by a background thread in a multi-threaded process so that a main thread can continue to process new frames 304 as they are created. The results of a local bundle adjustment calculation are updated coordinates for all the key frames 307 and map points 310 (i.e., the camera poses for all the key frames 307 and positions for the map points 310) amongst the neighbouring key frames, and a list of outlier associations between features 306 and map point 310 to be deleted from the map 309. The local bundle adjustments are applied to the map 309 in an atomic operation. Once the local bundle adjustment calculations are applied, the current pose of the camera 30 is recalculated. As a result, the reported position and/or orientation of the vessel 10 can sometimes be seen to jump in response to a local bundle adjustment.

If a new local bundle adjustment has not started some time after the previous local bundle adjustment has completed (for example, after several seconds), a global bundle adjustment may commence. The global bundle adjustment is a non-linear least squares fit to refine the calculated pose of the camera 30 for the key frames 307 and map points 310. The global bundle adjustment calculation works the same way as the local bundle adjustment, but includes all of the key frames 307 and map points 310 in the map 309 (not just neighbouring key frames). If a new key frame 307 is added while a global bundle adjustment is in progress, the global bundle adjustment may be abandoned. The global bundle adjustment may take tens or hundreds of seconds to complete, but it will only be run when not actively building the map 309 so as not to interfere with the map building process.

### Assessing Accuracy and Integrity of Pose Estimates

With every position, and optionally orientation, of the vessel 10 calculated by the map 309, the system can provide confidence limits (indicating how accurate the position, and optionally orientation, of the vessel 10 is, assuming a reasonably good set of matches between features 306 and map points 310 has been made) and an integrity score (indicating the risk that the position, and optionally orientation, of the vessel 10 reported is a long way from the true value).

The residual errors from calculating the position, and optionally the orientation, of the vessel 10 from the map 309 can be used to calculate confidence limits for the position, and optionally the orientation, of the vessel 10.

Association scores can be calculated based on the proportion of map points 310 which are currently in the field of view of camera 30 which are being associated with features 306 in the current frame, and the proportion of features 306 in the current frame which are being associated with map points 310. These association scores act as an integrity check on the current reported position. If the proportion of associated map points or features is low, then this indicates that the scene looks very different now from how it looked when the map was built. This may indicate a blunder error in the position reported by the GNSS receiver 15.

### Independence From GNSS

A dynamic positioning system on a vessel, such as vessel 10, usually has multiple position determining means. For safety, it is preferable that these position determining means are independent of each other. The system 40 may compromise independence between position determination by the GNSS receiver 15 and position determination by the map because GNSS data is required to build the map.

Live GNSS data is only required when actively building or maintaining the map 309. Calculating the position, and optionally the orientation, of the vessel 10 from the map 309 does not require access to the live GNSS data as long as the region of the marine environment 20 the vessel 10 is operating within is sufficiently well-mapped, since the position, and optionally the orientation, of the vessel 10 can be determined solely from the map 309 without requiring live GNSS data.

To ensure independence when the vessel 10 is performing a critical operation, the GNSS receiver 15 may be temporarily disconnected from the system 40, for example, by disconnecting or deactivating the communications link 17 between the GNSS receiver 15 and the computer 35. While the system 40 is temporarily disconnected from the GNSS receiver 15, GNSS data is stored. Any new key frame(s) 307 added to the map 309 may be added without a GNSS fix but with a flag to say that a stored GNSS fix is available in the stored GNSS data. The GNSS data may be stored on the computer 35 by an independent process segregated from the map building process. Alternatively, to make it easier to prove that no current GNSS data is contributing to the calculation of the position or orientation of the vessel 10 from the map 309, the GNSS data can be stored off the computer 35 (such as on the GNSS receiver 15 or on another independent data storage device).

After a critical operation is completed, the GNSS receiver 15 can be reconnected to the system 40 and the stored GNSS data can be retrospectively applied to the map 309: the stored GNSS data is transcribed to the features of the relevant key frames 307 and a bundle adjustment adjusts the map points 310 to account for the stored GNSS data that has been added. This approach has a drawback. Once the GNSS receiver 15 has been disconnected from the system 40, there is a delay before it can be confirmed that the system 40 is working truly independently of the GNSS data.

The system 40 may only operate without live GNSS data while it is determined that the vessel 10 is operating in a sufficiently well-mapped region of the marine environment. To determine whether the vessel 10 is operating in a sufficiently well-mapped region, the system 40 may calculate a map quality metric indicating how well the region in which the vessel 10 is currently operating is mapped. The map quality metric for the region may be compared to a map quality threshold. If the map quality metric for the region is greater than the map quality threshold, the system 40 may operate without live GNSS data (i.e., determining position of the vessel 10 using the map without using position or orientation data from the vessel 10) while the vessel is operating in the region.

A map quality metric may be calculated by counting the number of map points 310 which are associated with both features 306 in the current frame 307c and with at least two key frames 307 for which GNSS fixes are available. If the count is above the map quality threshold, the system 40 may operate without live GNSS data.

More generally, the map quality metric may be determined using the concept of “topological distance”. A key frame 307 with a GNSS fix can be said to be at a topological distance of zero from the geo-referenced part of the map 309. The system 40 can work through the remaining key frames 307 recursively, assigning a topological distance from the geo-referenced part of the map 309 to each key frame 307. Given that the system 40 has found all the key frames 307 which are at a topological distance of d or less, it says that a key frame 307 is at a topological distance of (d+1) if the number of map points which are associated with a feature in that key frame and with at least two key frames which are at a topological distance d or less is above a threshold. Then if the current frame 307c is at a topological distance from the geo-referenced part of the map which is no more than a topological distance threshold, dₘₐₓ, the system may operate without live GNSS data.

So far, the strength of the connection between two key frames 307 has been measured simply by counting the number of map points 310 the two key frames 307 have in common. The two key frames 307 are said to be connected if the count exceeds a threshold. There are other ways to measure the strength of the connection between two key frames 307. For example, all of the feature measurements for the shared map points may be processed to calculate the change in pose of the camera 30 from one key frame to the other. By modelling the likely measurement errors, the system 40 can also calculate a covariance for that estimate using techniques well-known in the field of estimation theory. If all of the eigenvalues of that covariance matrix are below some threshold, the system 40 can treat the two key frames 307 as connected.

GNSS fixes acquired while the map quality metric is above the threshold may be stored. GNSS fixes each have a timestamp indicating the time at which the GNSS fix was collected. A timestamp is applied to each frame 304 based on the time at which the image 302 associated with the frame 304 was captured by the camera 30. Preferably this timestamp is from a GNSS synchronised clock, either in the camera 30 or in the computer 35. GNSS synchronised clocks can be synchronised to the GNSS receiver 15 or to some other GNSS system. It is not necessary to have a continuous GNSS connection to the GNSS source as long as any GNSS synchronised clocks can be periodically synchronised with the GNSS source (for example, every few hours).

Any key frames 307 added to the map 309 while the map quality metric is above the threshold (and operating independently of live GNSS data) are flagged to indicate the availability of a GNSS fix for updating once GNSS is reconnected. Operating without live GNSS data continues until the count drops below the threshold.

A GNSS fix is added to the oldest key frame (based on timestamp) for which a GNSS fix is available but has not yet been used. The age of the youngest key frame (based on timestamp) for which a GNSS fix is available but has not been used is monitored. When this age is above a threshold (say 1 minute), it is declared that the system 40 is ready to operate independently of GNSS. The benefit of this approach is that when the system 40 is ready to operate independently of GNSS, there is no delay while waiting to confirm that the system 40 is working truly independently of live GNSS data.

While operating independently of live GNSS data, the age of the GNSS fix used most recently in the map building process (that is, the GNSS fix most recently applied to a key frame 307) may be supplied along with the position, and optionally orientation, of the vessel 10 determined by the map 309. This age provides a measure of the extent to which the system 40 is truly independent of live GNSS data

When the system 40 is not actively being used for determining the position of the vessel 10, the system 40 can switch to a GNSS-dependent mapping mode in which GNSS fixes are fed directly to the system 40 at all times. This compromises the ability to detect some GNSS failure modes (such as multipath or spoofing), but this is not a significant problem when the system 40 is not being actively used to determine the position of the vessel 10, and allows the map to be built more quickly.

### Getting Lost

If the number of tracks 308 falls below a lost threshold, the vessel 10 is declared lost. If, upon being declared lost, there are a relatively small number of key frames 307 in the map (for example, less than six key frames), the map 309 may be dropped, returning to map initialisation.

When lost, an attempt can be made to obtain the current position of the vessel 10 from the GNSS receiver 15 and current orientation of the vessel 10 from the orientation data. Then, the map 309 can be searched to identify all of the map points 310 which should be in the field of view of the camera 30 from the current position and orientation and a set of visible features predicted. If the number of predicted visible features is greater than the lost threshold, relocalisation of the vessel 10 in the map is attempted, for example, using particle filter relocalisation. However, if there are no features in any map which are in view, a new map can be started with a new map initialisation process.

### Relocalisation

A relocalisation calculation starts with an estimate of the pose of camera 30 given the current GNSS position data and inertial orientation data and uses the set of map points 310 which are expected to be in the current field of view of the camera 30 to predict the features 306 that should be visible. An attempt is made to match between the predicted features and the features observed in the current frame. On a first pass search, matching is based on a fairly close match in descriptor value, with a fairly large difference in feature position between prediction and observation permitted. Once potential matches have been obtained, a refined pose for the camera 30 is solved. The refined pose can be used to generate a new set of matches between predicted and observed features and the refined pose of the camera 30 can be solved for a second time. This process may continue iteratively. Once the number of matches exceeds a threshold (at least as high as the “lost” threshold), a new key frame 307 is added and map building resumes.

### Map Fusion

The system can maintain a set of maps called an “atlas”, although only one map is actively being built or tracked by the vessel 10 at any one time. Each map is a fully connected set of key frames 307 and map points 310 which are disconnected from every other map in the atlas.

For each map we can calculate the region covered by that map, that is, the region where a significant number of map points 310 covered by that map are expected. When the vessel 10 crosses into a region covered by a different map (i.e., different to the currently active map), a map relocalisation can be attempted to that other map. If the relocation is successful, a new key frame 307 can be created which links both maps and the two maps may be merged into a single map.

### Remote Map Server

The system 40 may upload maps of the marine environment 20 to a remote server (for example, in the cloud). These maps may be downloaded by other vessels that are visiting the marine environment 20 for the first time and do not yet have their own map, or the other vessels may not have visited the marine environment 20 for some time so may download a more up-to-date map that may be available. Similarly, the vessel 10 may download a map from the remote server for a marine environment that the vessel 10 has not yet visited and does not have a map, or may download an update to an existing map (for example, to correct errors or expand the coverage of the existing map).

The upload and/or download of maps will typically take place when the pose of the vessel 10 has not changed substantially for a length of time (for example, 30 minutes) to make it more likely that the map is not actively being updated, and when there is a strong mobile data signal.

The remote server may run a map fusion process which examines new maps as they are uploaded for overlaps. If two maps overlaps, the two maps are fused. Unlike the on-vessel map fusion described above, where one map grows until it touches another map and maps can be merged while there is still relatively little overlap, remote map fusion often results in maps with substantial overlap and redundant (duplicated) map points. To address this, map points in one map are matched with map points in the other map and redundant (duplicated) key frames deleted.

The remote server may remove map data from the maps based on the identity of the vessel that provided the data. For example, the remote server may remove all map data provided by a vessel that has consistently provided inaccurate map data.

When updating an existing map, rather than downloading the entire map, which may be time consuming over a mobile data connection and increase the chance of errors, the remote server can provide information on the changes required to update the existing map to the updated version. That is, the remote server may hold a version repository for the map indicating the changes made between versions.

The vessel 10 may provide an itinerary to the remote server indicating where the vessel 10 wishes to travel next. The remote server can then provide a (new or updated) map which covers the itinerary, in order to limit the amount of map data that needs to be downloaded to only that which will be useful for the itinerary.

Although the invention has been described in terms of certain embodiments, the skilled person will appreciate that various modification could be made which still fall within the scope of the appended claims.

The invention has been described in terms of building a map by capturing images of the marine environment 20 with camera 30. However, any alternative image capture device could be used instead to capture images of the marine environment 20, as long as the images created by an alternative image capture allow distinctive features to be identified and extracted from the images.

Examples of suitable alternative image capture devices are a lidar or RGB-D depth camera. In some ways, lidar and RGB-D depth cameras provide a simpler and more robust system for building the map. Lidar usually delivers accurate angles, so intrinsic calibration is not necessary (an RGB-D camera requires intrinsic calibration, but this is best achieved by looking at a 3D calibration object). The lidar or RGB-D camera provide three-dimensional co-ordinates, including a depth measurement, for features in an image. Therefore, unlike creating map points with two-dimensional images provided by a regular camera, images from the lidar or RGB-D cameras allow a map point to be created from a single feature in a key frame (in contrast, a regular camera requires at least two corresponding features each in different key frames to create a map point). When a key frame is added to the map, it is possible to create a map point for every feature in that key frame. As a result, it is not necessary to handle features in the key frame that are not associated with a map point.

Although the invention has been illustrated using the example of marine vessel 10 operating in a marine environment 20, the invention is equally applicable to determining the position of other objects in different kinds of environments. For example, the invention may be applied to any vehicle, for example, cars, trucks, buses, coaches, heavy equipment (including construction, mining, agricultural, and forestry vehicles), trains, helicopters, spacecraft, aircraft and drones). A map can be generated as a vehicle moves around its environments in the same way as described above for the marine vessel 10. This map can then be used to verify the accuracy of GNSS position data relating to the vehicle, or to determine the position of the vehicle when GNSS is not available or deemed inaccurate in the same way as described above for the marine vessel 10.

1. A computer-implemented method of determining a position of a vessel in a marine environment, the method comprising:
obtaining image data representing the marine environment;
obtaining position data from the vessel representing the position of the vessel in the marine environment;
generating a map of the marine environment based on the image data and the position data from the vessel; and
determining a map quality metric of the map for a region of the marine environment and, in response to determining that the map quality metric for the region of the marine environment is greater than a map quality threshold, determining a position of the vessel using the map without using position data from the vessel while the vessel is operating in the region.

2. The computer-implemented method of claim 1, further comprising:
generating the map of the marine environment based on the image data and the position data from the vessel when the map quality metric is below the map quality threshold; and
storing the position data from the vessel when the map quality metric is above the map quality threshold and updating the map based on the stored position data when the map quality metric is below the map quality threshold.

3. The computer-implemented method of claim 1, 2, wherein
the image data comprises a time series of images, each image representing the marine environment around the vessel at a point in time;
generating the map comprises:
generating a plurality of frames, wherein each frame comprises one or more features extracted from an image of the time series of images and at least some of the plurality of frames comprise a position fix based on position data from the vessel;
generating the map based on key frames selected from the plurality of frames; and
generating one or more map points, wherein each map point identifies the position of a feature in the marine environment based on the position data from the vessel; and
determining the map quality metric comprises:
obtaining current image data representing the region of the marine environment;
generating a current frame comprising one or more features extracted from the current image data; and
determining the map quality metric based on the map points associated with features in the current frame and features in the key frames having a position fix.

4. The computer-implemented method of claim 3, wherein the map quality metric is determined by counting the number of map points associated with features in the current frame and features in the key frames having a position fix and the map quality threshold is based on the count.

5. The computer-implemented method of claim 3, wherein the map quality metric is determined based on topological distance between the current frame and key frames having a position fix, and the map quality metric is above the map quality threshold when the topological distance is less than a topological distance threshold.

6. The computer-implemented method of claim 3, wherein generating the map comprises:
defining one or more tracks for a first frame of the plurality of frames, wherein each of the one or more tracks associates a feature in the first frame with a map point;
extending at least some of the one or more tracks by matching the track with a corresponding feature in one or more subsequent frames of the plurality of frames; and
determining the position of the vessel in a current frame based on the position of map points matched to features in the current frame by the tracks.

7. The computer-implemented method of claim 6, wherein matching a track with a corresponding feature is based on one or more of: the distance between the track and the corresponding feature, and the characteristics of the features.

8. The computer-implemented method of claim 7, wherein matching the track with a corresponding feature in one or more subsequent frames comprises predicting the position of the corresponding feature in the one or more subsequent frames, for example, using a Kalman filter.

9. (canceled)

10. The computer-implemented method of claim 6, wherein in response to the track failing to match with a corresponding feature in one or more subsequent frames, the track is extrapolated between frames or deleted.

11. The computer-implemented method of claim 6, further comprising:
identifying one or more map points that are not associated with a track;
in response to determining that an identified map point is expected to be visible in the current frame, matching an unassociated feature in the current frame with the identified map point; and
defining a track for each of the map points matched with an unassociated feature.

12. The computer-implemented method of claim 6, further comprising removing a map point from the map in response to the removed map point matching no features over a number of frames exceeding a removal threshold.

13. The computer-implemented method of claim 6, where a new key frame is added to the map in response to one or more of:
the number of tracks in a current key frame falling below a track threshold;
a distance travelled by the vessel from the current key frame exceeding a distance threshold;
the number of map points associated with the current key frame that are not associated with the current frame exceeding an association threshold;
a minimum number of maps points being associated with the current frame; and
the new key frame, or a neighbouring key frame, having associated position data, and optionally orientation data, from the vessel that is not deemed inaccurate.

14. The computer-implemented method of claim 13, wherein a key frame is removed from the map in response to determining that the key frame is redundant based on the number of map points duplicated in other key frames.

15. (canceled)

16. The computer-implemented method of claim 13, further comprising performing a bundle adjustment which adjusts a pose of an image capture device associated with one or more key frames and/or one or more maps points to minimise a reprojection error and/or an error between the calculated position of the vessel and the position data from the vessel.

17. The computer-implemented method of claim 16, wherein the bundle adjustment removes tracks from the map that cause a reprojection error to exceed a reprojection error threshold.

18. The computer-implemented method of claim 6, further comprising declaring the vessel lost in response to the number of tracks falling below a track threshold and, in response to declaring the vessel lost, either: relocalising the vessel in the map; or generating a new map.

19. The computer-implemented method of claim 1, wherein the map is generated as the vessel moves around the marine environment, optionally the map is generated on a plurality of visits by the vessel to a region of the marine environment.

20. The computer-implemented method of any claim 1, further comprising merging the map with a shared map stored on a server and updating the map based on the shared map, optionally wherein the shared map comprises map data generated by a plurality of vessels.

21. (canceled)

22. A computer-readable medium having instructions which, when executed be a processor, cause the processor to carry out a method of determining a position of a vessel in a marine environment according to claim 1.

23. A system to determine a position of a vessel in a marine environment, the system comprising:
an image capture device configured to provide image data representing the marine environment; and
a device comprising a processor configured to:
receive the image data representing the marine environment from the image capture device;
receive position data representing the position of the vessel in the marine environment from a position sensor on the vessel;
generate a map of the marine environment based on the image data and the position data; and
determine a map quality metric of the map for a region of the marine environment and, in response to determining that the map quality metric for the region of the marine environment is greater than a map quality threshold, determine a position of the vessel using the map without using position data from the position sensor on the vessel while the vessel is operating in the region.
